(19) United States
(12) Patent Application Publication
(10) Pub. No.: US 2002/0191565 A1
(43) Pub. Date: Dec. 19, 2002

(54) Methods and systems employing receive diversity in distributed cellular antenna applications

(76) Inventors: Sanjay Mani, Palo Alto, CA (US); David Cutrer, Fremont, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/117,433

(22) Filed: Apr. 4, 2002

Related U.S. Application Data
(63) Continuation-in-part of application No. 10/012,264, filed on Nov. 5, 2001.
(63) Continuation-in-part of application No. 10/012,246, filed on Nov. 5, 2001.
(63) Continuation-in-part of application No. 10/012,248, filed on Dec. 11, 2001.
(60) Provisional application No. 60/296,781, filed on Jun. 8, 2001.
(60) Provisional application No. 60/313,360, filed on Aug. 17, 2001.

(51) Int. Cl. H04Q 7/00; H04B 10/00

(52) U.S. Cl. 370/334

(57) ABSTRACT

A network comprises a plurality of antennas remotely located from and optically coupled to a base station is provided The base station has a plurality of receive or transmit/receive ports. The antennas are split into a plurality of groups equal in number to a number of receive ports. The uplink signals from each group of antennas are connected to one of the receive ports of the base stations by signal combination. A plurality of links couple the remotely located antennas and the base stations.

### CROSS-REFERENCE TO RELATED APPLICATIONS

This application is a continuation-in-part of U.S. Ser. No. 10/012,264 filed Nov. 5, 2001 is a continuation-in-part of U.S. Ser. No. 10/012,246 filed Nov. 5, 2001 and U.S. Ser. No. 10/012,248 filed Nov. 5, 2001, U.S. Ser. No. 10/012,264 also claims the benefit of U.S. Ser. No. 60/296,781 filed Jun. 8, 2001 and U.S. Ser. No.: 60/313,360 filed Aug. 17, 2001, all of which applications are incorporated herein by reference.

### BACKGROUND OF THE INVENTION

1. Field of the Invention

This invention relates generally to cellular mobile telecommunication systems, and more particularly to employing cellular base station equipment with a distributed set of transmit/receive antennas.

2. Description of Related Art

Cellular networks are typically deployed by co-locating antennas and base stations at sites that are either bought or leased and can support such installations. FIG. 1 illustrates a typical rooftop cellular site, while FIG. 2 depicts a typical deployment architecture. The antenna is located close to the base station, generally within 100 feet, and connected to the base station employing lossy RF cable.

An alternate architecture can be employed in which the base station is placed at a central or accessible location, and then remote antennas are connected to the base station using optics or RF cable. Such an architecture is employed where the topology or mobile traffic patterns are appropriate, such as in buildings or on roads. In an in-building application, a base station can be placed in a room, and then the entire building is covered with small antennas, connected to the base station over a cable and/or optical network.

Another application covers outdoor narrow canyons or roads through lightly populated areas. In these areas, it is difficult to site a base station at the desired coverage location. In addition, the geometry of the location may not be reasonable to cover with a conventional base station. A canyon may be a long narrow area with a few cars in it at any given time, in which placing many base stations along the canyon would waste a large amount of capacity. The solution to this problem is to employ a distributed antenna network to cover the canyon, and then connect that network to a base station placed at a location where it is relatively easy to site. This network can employ a point-to-point repeater link, in which the near end is connected to the base station and the far end is connected to the antennas. The link carries uplink and downlink signals from one or a group of antennas to a base station on a proprietary link.

The links can be optical fiber or some form of RF cabling, and generally include amplification so that the distance is covered with no loss in signal intensity, even if the signal properties are degraded by the link. A power amplifier placed at the remote location is used to amplify the downlink signal, while a low-noise amplifier at the remote location is used in the uplink direction, also to amplify the signal. The repeater architecture allows coverage to be cost-effectively extended to areas that are difficult to site multiple base stations for either financial or physical reasons.

A common implementation to extend coverage is to use a base station and several optical fiber links with remote antenna locations. When the goal is coverage, often multiple fiber links are used on a single base station in order to distribute the signals from the base station over multiple antennas. Such an implementation is illustrated in FIG. 3. Three repeaters are connected to one base station, employing power combiners/dividers to split the signal between the multiple repeaters. The remote repeaters are linked optically to the base station unit. On the downlink, the base station transmit signal will be split to cover the various repeaters, and on the uplink the signal from these multiple repeater receivers can be power combined and connected to a base station receive port. That means that the base station is distributing its transmit signal to multiple transmitters on the downlink and receiving power combined signals from multiple receivers on the uplink. This configuration allows one base station to cover a large area that isn't readily covered by a conventional base station through a distributed network.

In addition to the single RXreceive port or TX/RX duplex transmit/receive port, many base stations possess an additional diversity receive port. In a conventional base station, this additional port would be connected to a different receive antenna, as illustrated in FIG. 4. The diversity receive port allows for two spatially diverse receive antennas to be used, and they are typically separated by at least (receive wavelength)/2. Diversity receive reduces the likelihood of Raleigh fading hurting uplink reception. In Raleigh fading, multiple signal paths from the mobile transmitter to the BTS antenna cause dramatic oscillations in the received signal intensity from multipath signal addition. If Raleigh fading creates a dramatic signal reduction at one RX antenna, it is unlikely to create a deep fade at the spatially separated RX antenna at the same time. Hence, spatial receive diversity combats against Raleigh fades. These deep fades are a significant problem in cellular uplink reception. The two receive ports can have separate demodulation receive paths, in which case two demodulated signals can be generated and combined. This can result in up to a 3 dB increase in SNR, in addition to the greater immunity to Raleigh fade. Receive diversity can also be implemented in a simpler fashion, by merely choosing the larger signal, in which case the SNR increase is not realized. The diversity concept can be extended to more branches than 2, for greater immunity to fading.

There is a need for a distributed network combined with a base station with reduced and/or minimal Raleigh fade. There is a further need for a distributed network which passes to a base station an improved uplink signal. There is yet another need for distributed network that has a decrease in the uplink noise floor.

### SUMMARY OF THE INVENTION

Accordingly, an object of the present invention is to provide a distributed antenna system, and its methods of use, that utilizes diversity receive.

Another object of the present invention is to provide a distributed antenna system, and its methods of use, that has an improvement in the uplink signal.

A further object of the present invention is to provide a distributed antenna system, and its methods of use, that has a decrease in uplink noise floor.

Yet another object of the present invention is to provide a distributed antenna system, and its methods of use, that has multiple remote repeater units and their corresponding antennas divided into first and second groups, with each unit in both groups connected to one downlink signal, and the units in the first group coupled to a first receive or transmit/receive port, and the units in the second group coupled to a second diversity receive port.

These and other objects of the present invention are achieved in a network with a plurality of antennas remotely located from and optically coupled to a base station. The base station has a plurality of receive or transmit/receive ports. The plurality of antennas are split into a plurality of groups that is equal in number to a number of the plurality of receive ports. Uplink signals from each grouping of the plurality of are connected to one of the plurality of receive ports of the base stations by signal combination. A plurality of links couple the plurality of remotely located antennas and the plurality of base stations.

In another embodiment of the present invention, a network includes a plurality of antennas coupled to a base station that has a plurality of receive or transmit/receive ports. The plurality of antennas are split into a plurality of groups that is equal in number to a number of the plurality of receive ports. Uplink signals from each grouping of the plurality of are connected to one of the plurality of receive ports of the base stations by signal combination. A plurality of links couple the plurality of antennas and the plurality of base stations.

In another embodiment of the present invention, a network includes a plurality of antennas coupled by optical links to a least one RF signal combiner on the uplink to produce a single RF combined signal. The combined RF signal is coupled to a base station that has a plurality of receive or transmit/receive ports. The plurality of antennas are split into a plurality of groups that is equal in number to a number of the plurality of receive or transmit/receive ports. Each grouping of the plurality of is connected to one of the plurality of receive or transmit/receive ports of the base stations by signal combination. A plurality of links couple the plurality of antennas and the plurality of base stations.

In another embodiment of the present invention, a network includes a plurality of antennas optically coupled to a base station that has a plurality of receive or transmit/receive ports. The plurality of antennas are split into a plurality of groups that is equal in number to a number of the plurality of receive or transmit/receive ports. Uplink signals from each grouping of the plurality of are connected to one of the plurality of receive or transmit/receive ports of the base stations by signal combination. A plurality of links couple the plurality of and the plurality of base stations. A coverage generated by the downlink signal is smaller than the coverage area generated by the uplink signal. The coverage areas are arranged such that remote nodes in different groups, and so connected to different receive ports, have larger overlapping uplink coverage areas than overlapping downlink coverage areas.

### BRIEF DESCRIPTION OF THE DRAWINGS

FIG. 1 illustrates a prior art cellular site with a set of antennas on a rooftop and connected over a short RF cable to a base station radio/transceiver unit that is then backhauled to the cellular network.

FIG. 2 is a schematic diagram of a prior art deployment of cellular network with base station/antenna sites located at strategic points across a geographic area to provide coverage, and each site is backhauled to the cellular network via 1 or more T-1 digital links.

FIG. 3 is a schematic diagram of a prior art distributed repeater architecture that includes three remote repeaters optically connected to a base station over a one or more fiber links.

FIG. 4 is a schematic diagram of a prior art base station with diversity receive, with the transmit and receive ports of the base station combined with a diplexer and then connected to a primary antenna, and a second antenna is used for diversity reception.

FIG. 5 is a schematic diagram of one embodiment of a distributed base station network with a plurality of antennas and base stations that has multiple transmission paths between at least a portion of the base stations with at least a portion of the antennas

FIG. 6 is a schematic diagram of a MEMs switch and Add/Drop Multiplexer that can be used with the FIG. 1 network.

FIG. 7 is a schematic diagram of a SONET router that can be used with the FIG. 1 network.

FIG. 8 is a schematic diagram of an optical multiplex/demultiplexer that can be used with the FIG. 1 network.

FIG. 9 is a schematic diagram of a DWDM transmission embodiment of the FIG. 1 network.

FIG. 10 is a schematic diagram of a point-to-point TDM topology embodiment of the FIG. 1 network

FIG. 11 is a schematic diagram of one fiber cable 20 with a plurality of fiber strands which from the multiple transmission paths of the FIG. 1 network.

FIG. 12 is a schematic diagram of a FIG. 5 network that uses free space optical links.

FIG. 13 is a schematic diagram of a FIG. 5 network where at least a portion of the links are configured to provide a selectable allocation of capacity to at least some of the base stations.

FIG. 14 is a schematic diagram of a FIG. 5 network with multiple base station sites connected together.

FIG. 15 is a schematic diagram of a FIG. 5 network that includes a control box for at least a portion of the antennas in order to provide routing to selected base stations.

FIG. 16 is a schematic diagram of a FIG. 5 network with amplifiers included in the links.

FIG. 17 is a schematic diagram of a FIG. 5 network that includes a digital transceiver embedded between a base station and the network on a base station side, and a digital transceiver embedded between an antenna and the network at an antenna side.

FIG. 18 is a schematic diagram of a FIG. 5 network illustrating transmission of down link and up link signals.

FIG. 19 is a schematic diagram of a hub and spoke embodiment of the FIG. 5 network.

FIG. 20 is a schematic diagram of a FIG. 5 network with at least two base stations located in a common location and the antennas geographically dispersed.

FIG. 21 is a schematic diagram of a FIG. 5 network with base stations connected together for different operators and used to extend coverage from each operator to other operators.

FIG. 22 is a schematic diagram of a FIG. 5 network that directly connects to an MTSO.

FIG. 23 is a schematic diagram of one embodiment of the present invention with remote repeater units and their corresponding antennas placed on/near poles on a road and are connected to a single base station and divided into 2 alternating groups, with group being connected to a different receive port.

FIG. 24 is a schematic diagram is a schematic diagram of another embodiment of remote repeater units and their corresponding antennas placed on/near poles on a road and are connected to a single base station and divided into 2 alternating groups, with group being connected to a different receive port.

FIG. 25 is a schematic diagram that illustrates the improvement in signal-to-noise of the FIG. 23 and FIG. 24 embodiments when diversity receive is employed in multiple antenna application.

FIG. 26 is a schematic diagram that illustrates overlapping uplink diversity with differing uplink/downlink coverage areas.

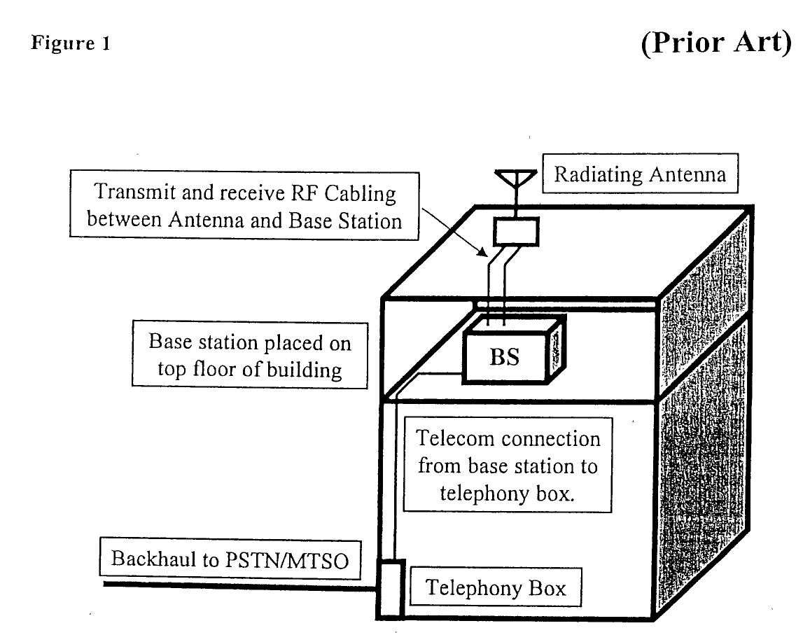

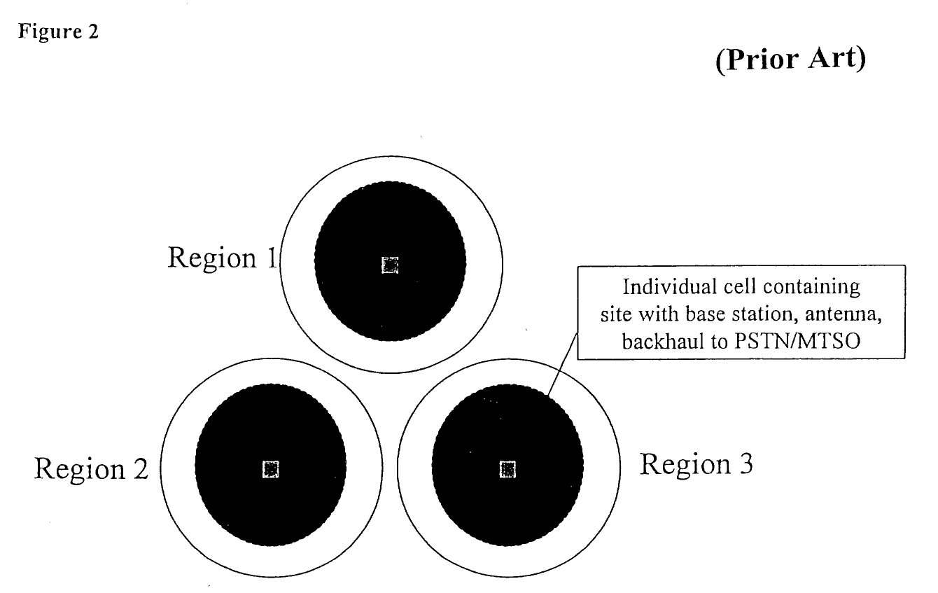

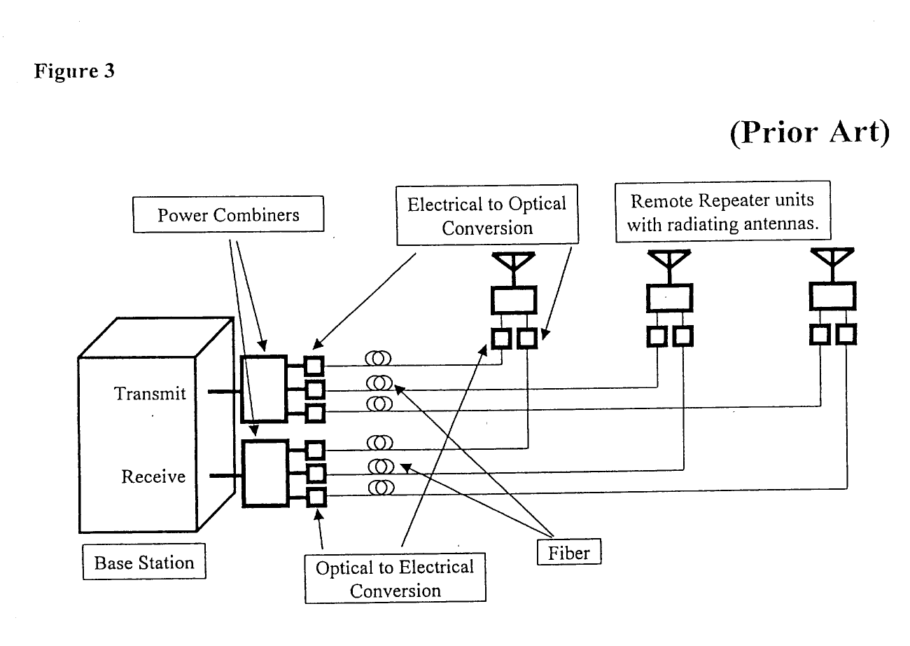

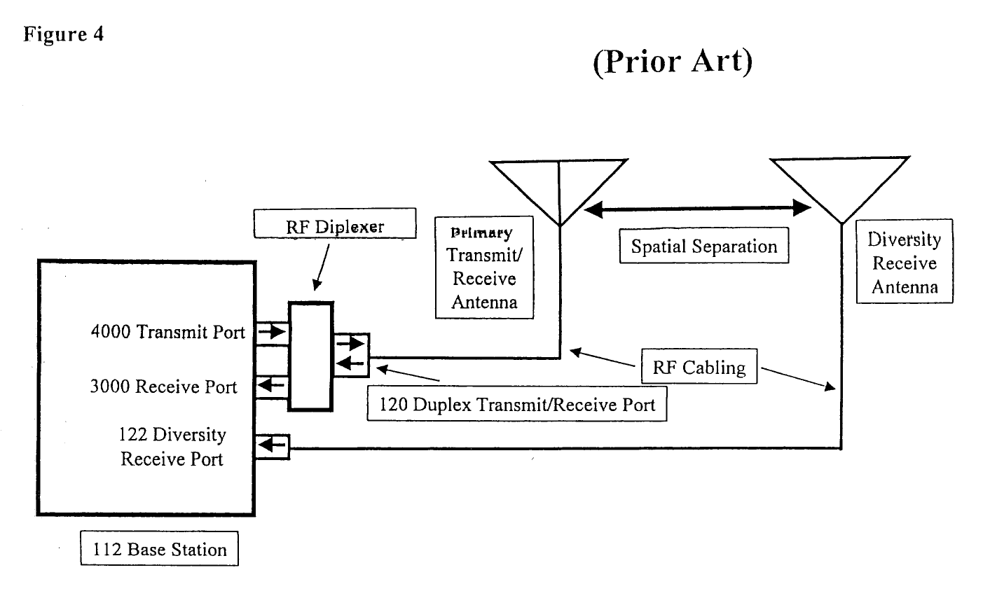

### DETAILED DESCRIPTION

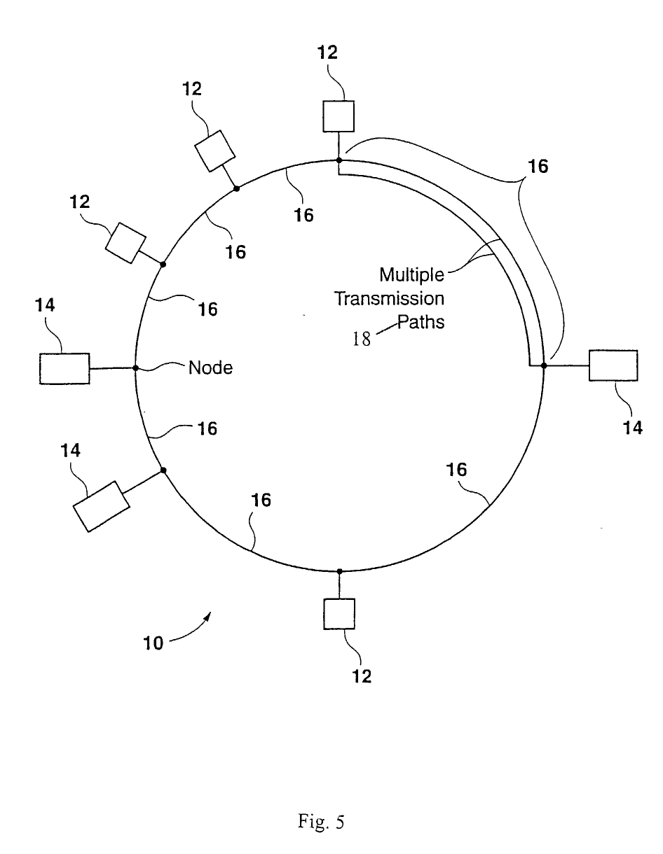

Referring to FIG. 5, one embodiment of the present invention is a network 10 that includes a plurality of antennas 12 that are optically coupled over network 10 to a plurality of base stations 14. Base stations 14 are configured to provide wireless cellular transmission. A plurality of links 16 couple the plurality of antennas 12 and the plurality of base stations 14. At least one link 18 of the plurality of links 16 provides multiple transmission paths between at least a portion of the plurality of base stations 14 with at least a portion of the plurality of antennas 12. In one embodiment, the plurality of antennas 12 and base stations 14 are coupled using RF links to form a network 10. By remotely locating the antenna 12 units from the base stations using such a network 10, numerous advantages are realized.

The plurality of links 16 can be configured to provide multiple transmission paths by frequency division multiplexing (FDM), time division multiplexing (TDM), and the like. Optically coupled networks can be configured to provide multiple transmission paths with wavelength division multiplexing (WDM) and/or multiple fiber strands that comprise a fiber cable. Both of these optical multiplexing techniques allow electrical isolation between different signals, because only the optical fiber and multiplexing components need be shared, not electrical components, optical transmitters, or optical receivers. TDM and FDM can both be combined with WDM to increase the number of transmission paths over a link. If the links 16 are RF microwave links, the multiple transmission paths can be different RF frequency channels.

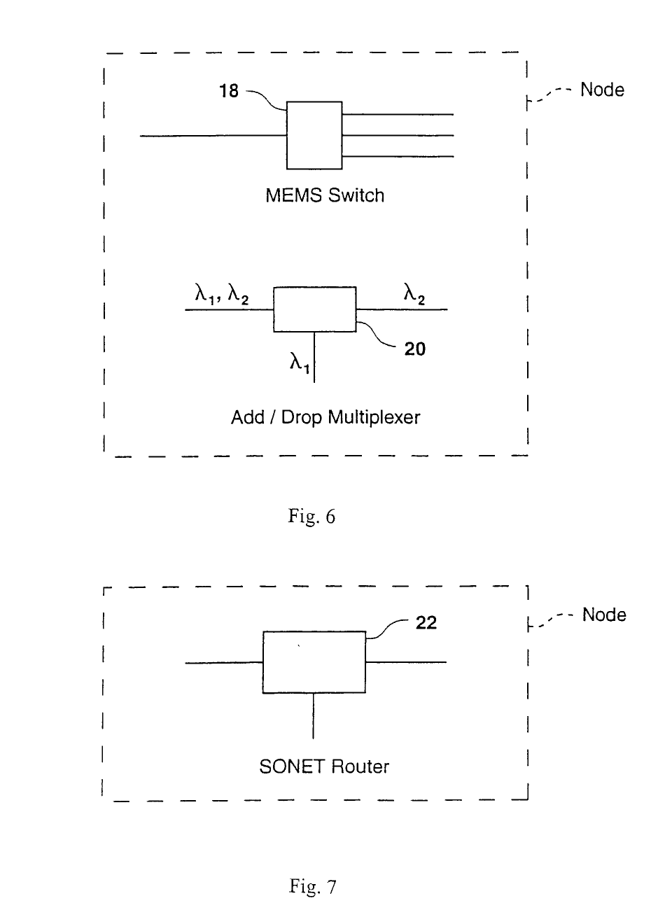

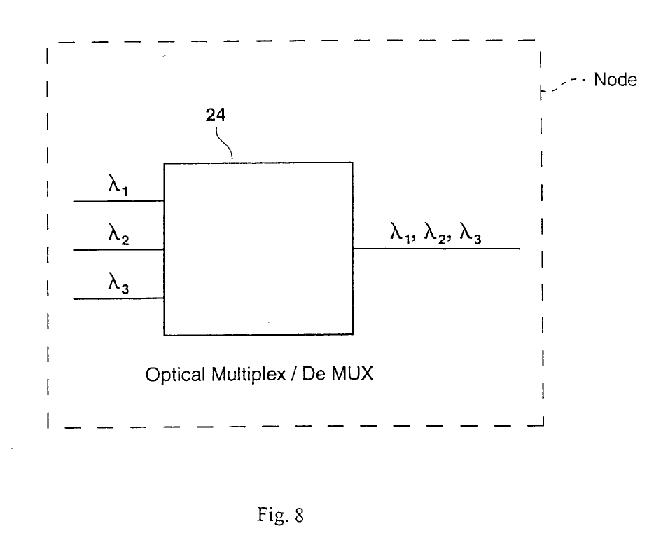

Optical WDM also allows multiplexing of different signals with very low latency, because no processing or switching operation need be performed, low latency optical directing components can be used exclusively. As illustrated in FIGS. 6, 7 and 8, optical multiplexing and routing can be performed with low latency passive or switching components including, but not limited to a MEMS switch 18, Add/Drop Multiplexer 20, Optical Multiplexer 24, and the like. Higher latency optical routing components such as a SONET router 22 can be used as well, if the latency budget is acceptable. FDM can also have low latency because RF mixing and combining are low latency operations, no processing or switching need be performed. Low latency is a desirable property for the invention, because placing a network between the antenna 12 and current base stations 14 places strict latency limitations on the network 10, as the network is now part of the conventional “air link” of a cellular system. This element of the link has strict latency constraints in modem cellular protocol standards, such as CDMA and GSM. However, other base station 14 embodiments can compensate for greater latency in this “air link” portion of the network 10, as it is a very small fraction of total latency in a wireless call. Such base stations permit much more flexible networking technology to be employed.

All or a portion of the links 16 can use optical FIG. 6 DWDM (Dense Wavelength Division Multiplexing) for transmission At least one link 16 can provide multiple transmission paths employing digital transmissions and DWDM multiplexing between at least a portion of the base stations 14 with at least a portion of the antennas 12. DWDM ring networks also can employ protection mechanisms, which can be important in the implementation of this invention, because if a fiber link breaks, multiple cellular sites will go down. Such protection operates by routing the optical signal in the opposite direction along the ring if there is a break. This routing can be accomplished by switching the direction of transmission around the ring on detection of a break, or by always transmitting optical signals between nodes in both directions, creating two paths for redundancy in case of a fiber break.

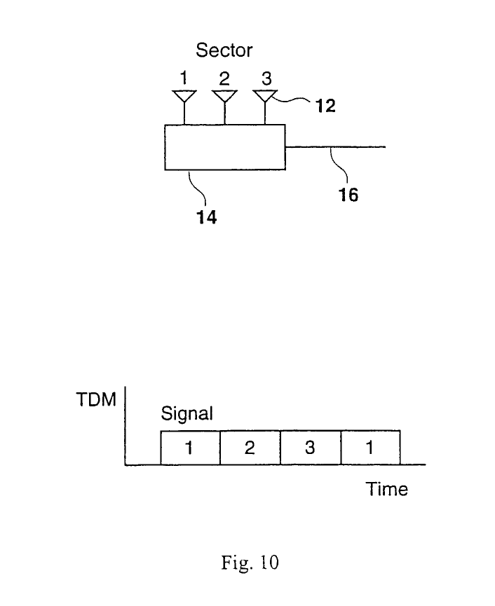

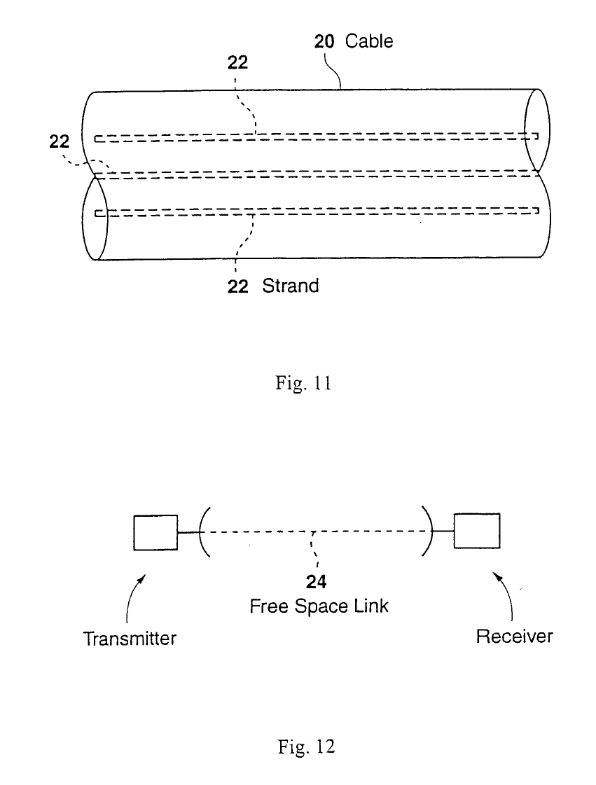

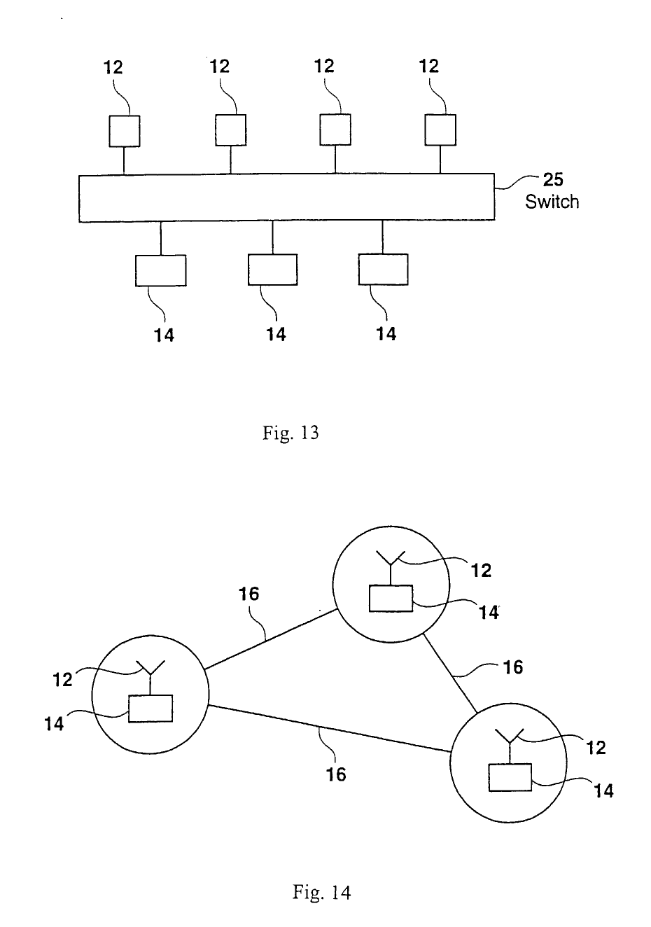

Some or all of the links 16 can use TDM (Time Division Multiplexing) to create the transmission paths. In one embodiment, the TDM employs SONET TDM techniques. In one embodiment, the TDM is specifically employed from one node to another node on the network 10 to carry multiple distinct RF signals in a point-to-point fashion. In a point-to-point TDM link, several signals are multiplexed together at an originating node, the multiplexed signal is then transported to the terminating node, and then the multiple signals are demultiplexed at the terminating node. Point-to-point TDM topology has the advantage of simplifying the multiplexing of multiple signals together, as opposed to adding and dropping low bit rate signals onto high bit rate carriers. Additionally, as illustrated in FIG. 10, the TDM link can carry multiple sectors of a base station 14. Further, the TDM link can carry multiple signals from different operators, carry diversity signals and be used to carry backhaul signals.

All or a portion of the links 16 can employ the SONET protocol, particularly using fixed optical paths. In such an embodiment, the SONET protocol is used to encode the signals, and then they are directed along fixed optical paths in a multiple wavelength optical network 10. A fixed optical path is one that is re-routed infrequently compared to the bit rate of the communication protocol employed over the path. This has the advantage of simplifying routing, since now only wavelengths need be routed. In a more flexible network 10, more complex SONET routing can be employed, for example, the links 16 can be multiplexed onto a SONET ring. In such a routing scheme, the multiplexing involves routing bits at the carrier bit rate of the ring, rather than routing optical wavelengths

Different optical wavelengths in a fixed or switched optical path configuration can also employ other protocols. In one embodiment, at least a portion of the links 16 employ Fibre Channel, Gigabit Ethernet, TCP, ATM or another transmission protocol. In one embodiment, at least one optical wavelength carries OA&M signals and in another embodiment, at least one TDM channel carries OA&M signals.

Full SONET routing can be used over the network 10. In such a case, low bit rate cellular signals are added and dropped off of higher bit rate SONET links, with flexible signal routing. SONET's low latency, TDM functionality, and wide availability for optical networking implementations make it a useful protocol for this application. In other embodiments, IP routing is used. Routing protocols can be combined with traffic data to route signals as needed to optimize capacity between a group of base stations 14 and remote antenna 12 nodes.

As noted earlier, network 10 can provide optical multiplexing. In this embodiment, the plurality of links 16 includes a plurality of optical fiber links. As illustrated in FIG. 11, at least one fiber cable 20 can be included with a plurality of fiber strands 22 which form the multiple transmission paths. For example, a 192 count fiber cable could be used for 192 fiber strands, allowing 192 signals to be multiplexed on the cable with no other form of multiplexing. Clearly, multiple cables can be exploited in the same way as multiple strands. In another embodiment, at least one optical fiber strand 22 transmits at least two optical wavelengths that form multiple transmission paths. Preferably, all of the optical fiber strands 22 transmit more than one optical wavelength. As an example, 6 strands could carry 32 wavelengths each, providing 192 transmission paths. Beyond this, each path could have 4 signals multiplexed onto it employing TDM, providing 4×192=768 transmission paths.

Referring to FIG. 12, in other embodiments, the plurality of links 16 is a plurality of free space optical links 24. In such links, one or more optical wavelengths are directed through free space. Such links are useful to employ in areas where fiber is expensive or unavailable. The plurality of links 16 can include both optical fibers and free space optical links 24.

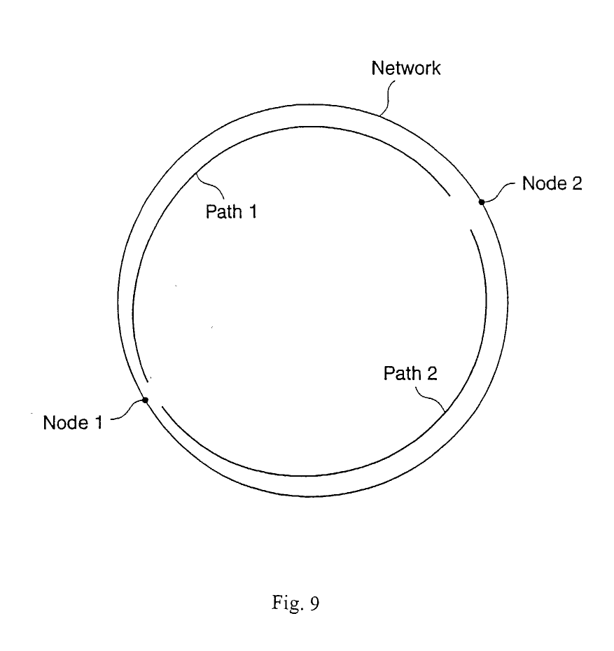

At least a portion of the plurality of links can be configured to provide selectable allocation of capacity to at least a portion of the plurality of base stations 14. This can be achieved with a control switching system 25. As illustrated in FIG. 9, such a system functions like a switch, in which the RF traffic from the antennas 12 are directed into it, and then redirected into base station 14 transceivers as needed. The switch 25 also takes the downlink channels and distributes them back to the antennas 12. The switch 25 can dynamically allocate the channel capacity of a group of base station transceivers to antennas 12 as needed. The capacity redirection switch 25 can be coordinated with the RF channel allocation, in order that the same frequencies are not used adjacent to each other. The switch allows the base station transceiver capacity to serve the entire geographic region covered by the antennas 12.

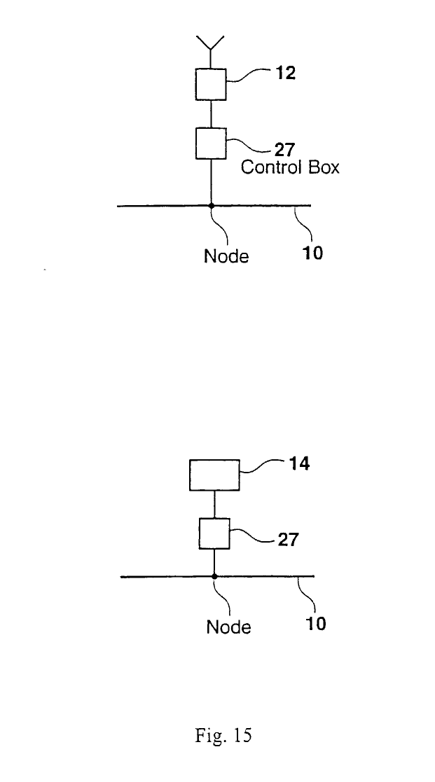

Referring to FIG. 14, a special case of shared base station transceiver capacity is to connect multiple existing base station 14 sites together, in order that the antennas 12 at these sites can be served by the transceiver capacity of all the base stations 14. The statistics of pooling transceiver capacity to cover larger geographic areas allows fewer base stations 14 to be used than if they were individually connected to single antennas. In addition, populations moving within the larger geographic area are covered by the same transceiver pool, which allows the number of transceivers to be sized with the population, not the geographic coverage area. This reduces the number of base stations 14 required to cover a given geographic area. In another embodiment shown in FIG. 15 a control box 27 can be included for each or a portion of the antennas 12 and provide routing to selected base stations 14. The routing by the control boxes 27 can be performed according to a desired schedule. For example, the switch could allocate more channels to highways during commute hours, and more channels to commercial office parks during business hours. One or all of the plurality of the links 16 can include a passive optical device 26. Suitable passive optical devices 26 include but are not limited to OADM's, filters, interleavers, multiplexers, and the like.

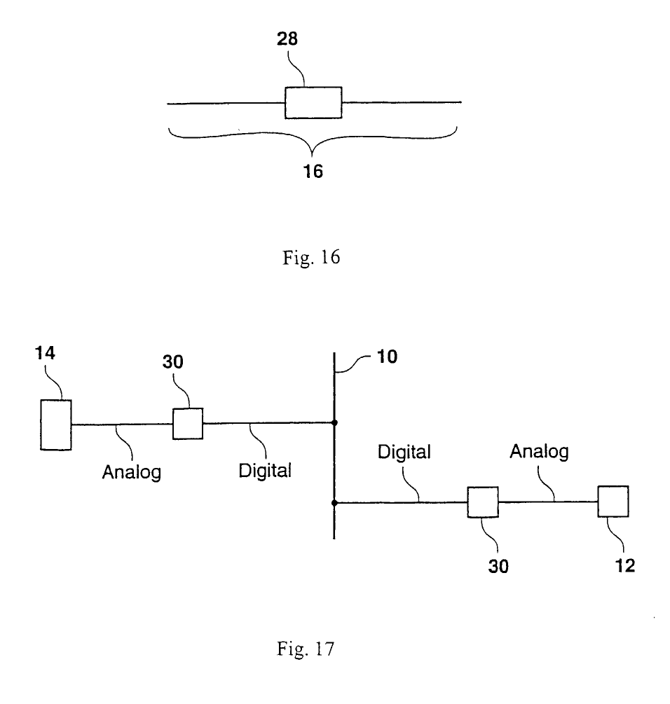

All of only a portion of the plurality of links 16 can include one or more optical amplifiers 28, FIG. 16. Optical amplifiers 28 are low latency devices that amplify optical signals, overcoming optical losses from fiber and the use of optical components. Such amplifiers 28 are commercially available in configurations that amplify blocks of wavelengths, which makes DWDM optical networking more feasible, especially given the optical losses sustained in wavelength multiplexing.

The cellular signals exchanged over network 10 can be analog signals or digitized. Analog signals generally involve modulating a laser or optical modulator with the cellular RF signal, or a frequency converted version of this signal. Such implementations have the advantage of simplicity, and can take advantage of WDM, multiple fiber strands 22 on a given fiber cable 20, and FDM. However, for such transmission, the channel properties of the link 16, such as noise figure and spur-free dynamic range, directly impact the signal properties. DWDM networks experience linear and non-linear crosstalk, causing signal interference between different wavelength carriers. This can create problems with analog RF transmission. Digital signals are streams of bits, generated by digitally encoding the analog cellular signal. The analog cellular signal is the signal that would normally be transmitted or received by the base station or the remote mobile units. So a PCS CDMA signal could be an “analog cellular signal.” It is not meant to imply that the signal is representative of an analog cellular standard. If the digital representation of the analog cellular signal is transmitted with a sufficient signal-to-noise ratio, it will not be significantly affected by link properties. Furthermore, these digital signals can be digitally protected with various strategies, such as encoding, parity, etc., to further reduce the likelihood of bit errors. By employing digital signals, there is a significant improvement in resistance to crosstalk. Hence DWDM and digital transmission is a powerful combination for exploiting the network 10 to carry the maximum number of cellular signals. Digital signals are furthermore amenable to the use of digital communications equipment and standards, such as routers, IP and SONET.

In one embodiment, the wavelength carriers carry an analog signal representative that is representative of an RF signal between multiple base stations 14 and antennas 12. Different carriers carry different cellular signals. In another embodiment, the wavelength carriers carry a digital signal that is representative of an RF signal between multiple base stations 14 and antennas 12. This digitization can be implemented in two preferred embodiments.

As illustrated in FIG. 17, a digital transceiver 30 is embedded between the base station 14 and the network 10 on the base station 14 side, and between the antenna 12 and the network 10 at the antenna 12 side, The coupling can be either a direct connection, or through one or more RF components such as an amplifier, attenuator, gain control block, and the like. The analog cellular signal, which is normally exchanged between these two units, is first converted into a digital signal by the digital transceiver, which is then exchanged over the network 10. After the digital cellular signal is received at the other end of the network, it is reconstituted by the digital transceiver as an analog cellular signal. This signal can be filtered, amplified, attenuated, and the like before being transmitted to the antenna 12, or the base station 14.

The other embodiment is to integrate the digital component into the base station 14 unit and the antenna 12 unit, and not use a separate digital transceiver. Although this can involve digitizing a wireless channel or frequency band, a more sophisticated implementation is to separate the functionality of the base station 14 unit and the antenna 12 unit at a point where the signal is itself digital. Given that the cellular RF signal is a digitally modulated signal, the voice channel is digitized, and base stations 14 are migrating to a digital transmit/receive architecture, there are several intermediate digital signals that could be exchanged. The antenna 12 units, when serving as remote units, can provide conventional base station 14 functionality such as baseband coding, channel coding, modulation/demodulation, channel filtering, band filtering and transmission reception and the like.

The general case is that each antenna 12 location can be configured to receive a downlink cellular signal as a digital stream input that is representative of a single or multiplicity of wireless channels or a segment of wireless spectrum. The antenna 12 then reconstructs and transmits the RF signal. Additionally, uplink cellular signals are received off-air at the antenna 12 that are representative of a single or a multiplicity of wireless channels from at least one mobile unit. At the antenna 12 node the uplink cellular signal is then converted into a single or plurality of bit streams. The bit streams are then transmitted over the network 10 to the base station 14 units. The base station 14 units receive this uplink digital signal and process it. Additionally, they transmit a downlink digital signal to the network 10.

When digital transceiver units are used to perform D/A and A/D functionality between antennas 12 and base stations 14, the analog signals can be frequency down converted before sampling and A/D conversion, and frequency up converted after D/A conversion. The digital signal can be serialized before transmission and converted back to a parallel signal after transmission. High bit rates, including but not limited to those greater than 500 Mbps, can be employed to create high dynamic range links for improved cellular performance.

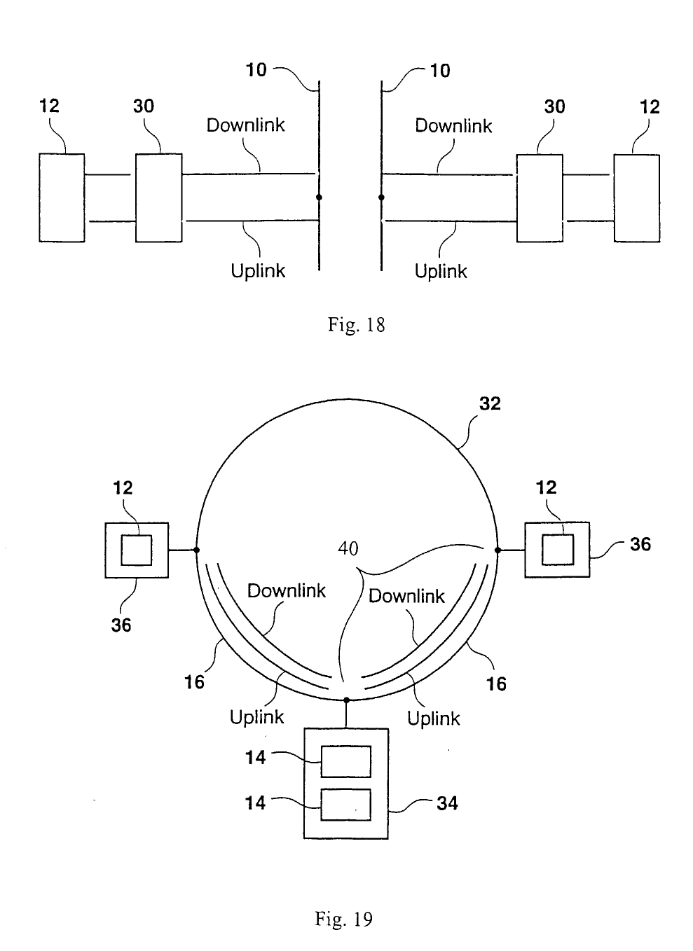

Referring to FIG. 18, when digital transceivers are employed, at the base station, the digital transceivers 30 digitize the downlink analog cellular signals that are representative of a wireless spectrum band or channel. Thereafter, the digital transceivers 30 pass the downlink digital cellular signals to the network 10. For the uplink at the base station, the digital transceivers 30 receive uplink digital signals representative of a wireless spectrum band or channel from the network, reconstruct the analog cellular signals, and then pass them to the base stations 14. At the antennas 12, for the uplink, the analog cellular signals received on the antenna 12 from the mobile units are converted into digital signals, and transmitted onto the network 10. The downlink digital signals are received by digital transceivers at the antenna 12, and then converted back into analog cellular signals representative of a wireless spectrum band or channel, and passed to the antenna 12.

In various embodiments, network 10 can have different layouts. In one embodiment, at least a portion of the plurality of the links 16 are fixed optical paths. Such paths involve connecting one or more remote nodes to one or more base nodes and rarely dynamically re-routing this path. The optical paths between antennas 12 and base stations 14 can have a one-to-one correspondence, connecting to one antenna 12 node and one base station 14 unit, or alternatively, one or more antennas 12 can be connected to one or more base stations 14 in a non one-to-one embodiment. In another embodiment, the transmission paths of network 10 can be dynamic-routable optical paths flexibly routed between one or a plurality of base stations 14 and one or a plurality of antennas 12.

As illustrated in FIG. 19, network 10 can be configured as a hub and spoke network 32. In this embodiment, the plurality of base stations 14 are located in a common node 34 and the plurality of antennas 12 are located at different remote nodes, generally denoted as 36 on the network 32. Optical uplink and downlink connections are spokes 38 that connect the common node 34 and the remote nodes 36. Network 32 can also include at least one set of nodes 40 containing the base stations 14 and/or antennas 12 which are connected by one or more links 16 that are laid out on a segment or a ring. Whether on a segment or a ring, in a preferred implementation the uplink and downlink should be transmitted in opposite directions to equalize the latency, which is important in cellular transmission.

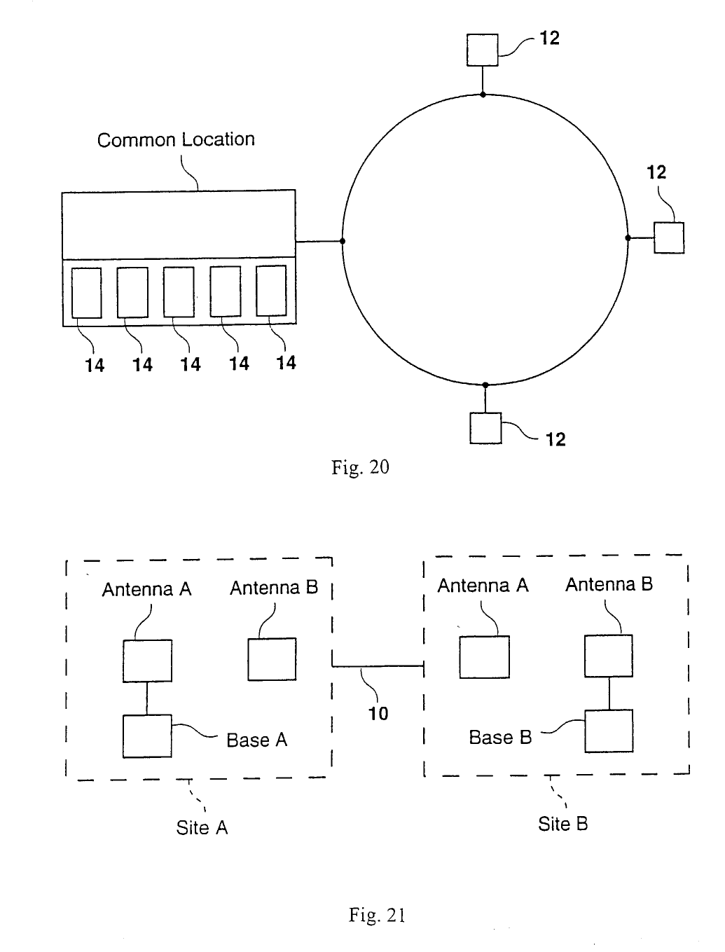

In one embodiment, at least two of the base stations 14 are located in a common location and the antennas 12 are geographically dispersed, FIG. 20. Suitable common locations include but are not limited to an environmentally controlled room in a building connected to the network 10. The antennas 12 are placed in areas providing the desired coverage which may have higher real estate costs and/or lower available footprints than the common location, but which can be connected to the network 10.

In various embodiments, at least one link of the plurality of links 16 can be, shared by at least two operators. The operators can be wireless operators, different spectrum bands used by a same cellular operator, different entities. This different operators need not share electrical components when using an optical network. Different operators can be multiplexed onto the network using any of the multiplex methods detailed previously. In a preferred implementation, the different operators can use different optical fibers strands, or different optical wavelengths on the same fiber strand. In another preferred implementation, different operators can employ different wavelengths on free space links. By optically multiplexing multiple operators on the same network 10, the operators can share the costs of constructing, acquiring and maintaining the network 10 without compromising their electrical isolation requirements. In one embodiment, the network 10 can be used to connect together existing base station 14 sites for different operators, and used to extend coverage from one operator to all other operators.

For example, as illustrated in FIG. 21, a site built by operator A at site A is connected to a site built by operator B at site B. An antenna 12 for A is placed at site B, connected to a base station 14 for operator A at site A, and an antenna 12 for operator B is placed at site A, connected to a base station 14 for operator B at site B.

In various embodiments, the links 16 provide that at least one optical carrier carries at least one backhaul signal from a base station 14 to a switch (such as an MTSO) or a bridge network. In an RF network, where the links 16 are RF links, the links 16 can be configured to provide that at least one RF carrier carries at least one backhaul signal from a base station 14 to one of a switch (such as an MTSO) or a bridge network.

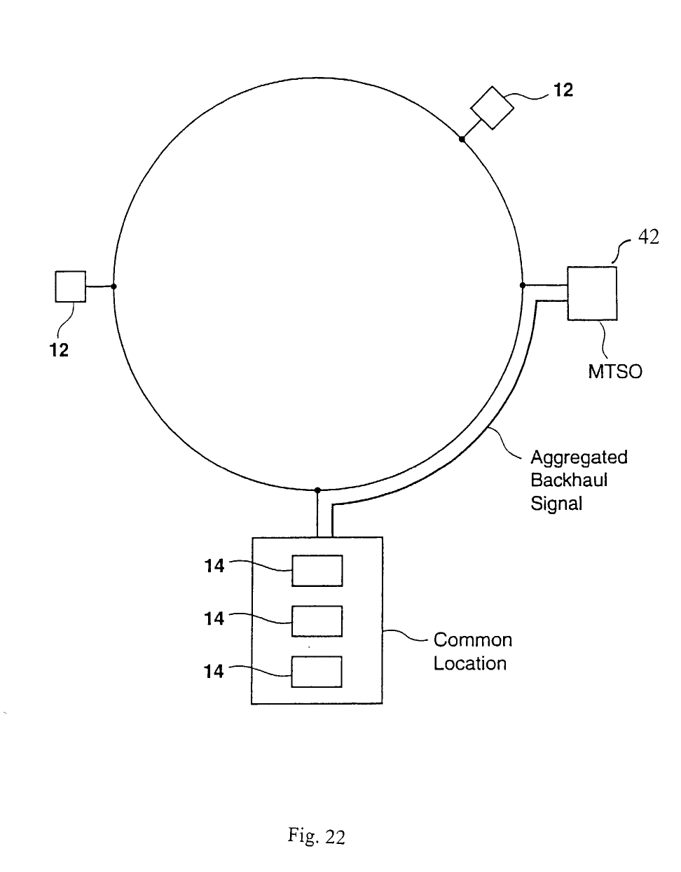

Referring now to FIG. 22, network 10 can be an optical network that directly connects to a switch 42, including but not limited to an MTSO. Multiple backhaul signals from several base stations can be integrated into one higher bit rate backhaul signal. This allows the network 10 costs to be shared amongst backhaul signals as well, and allows for high bandwidth backhaul to be performed, which is cheaper per bit. The backhaul signals can be digital t-carriers, SONET signals, and the like. Non-backhaul RF signals that share the network 10 with the backhaul signal can be represented digitally to minimize the effects of crosstalk with the digital backhaul signal. Non-backhaul RF signals can have a large wavelength separation from the backhaul signal in order to minimize the effects of crosstalk with the digital backhaul signal.

Some antenna 12 or base station 14 locations are difficult to connect to a network, especially an optical fiber network, because no fiber may exist to the site. In an embodiment of the invention, such a location can be connected to the network 10 with a free space link, either a free space optical link 16 or microwave link 16. This link 16 can be analog or digital, and if digital can be formatted in a proprietary fashion, or as a T-carrier or SONET link.

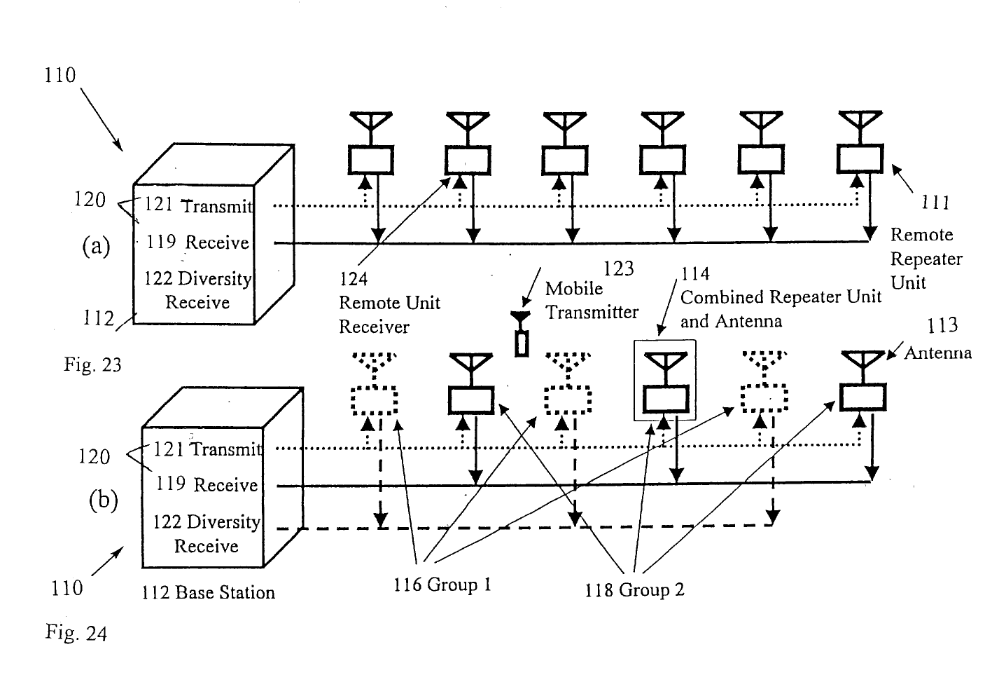

In another embodiment of the present invention, illustrated in FIG. 23, a distributed antenna system 110 utilizes diversity receive and has one or more base stations 112. Each base station 112 is connected to multiple remote repeater units 111 and their corresponding antennas 113, with the combined assembly being object 114. It will be appreciated that the combined assembly 114 can have more than one antenna 113. The downlink RF signal is power divided into multiple signals, and then distributed to individual remote repeater units 111 and their corresponding antennas 113. The uplink RF signals from multiple remote units 114 are power combined. Remote units 114 are split into two or more groups 116 and 118 for each base station 112. Each base station 112 has a simplex receive port 119 or duplex transmit/receive port 120. It also has one or more diversity receive ports 122. Each remote repeater unit 112 in both groups 116 and 118 is connected to one downlink port, either simplex transmit port 121 or duplex transmit/receive port 120. However, only one of the groups 116 or 118 is coupled to the uplink receive port 119 or transmit/receive port 120 and the other group 116 or 118 is coupled to diversity receive port 122. It will be appreciated that this grouping can be extended to more than one diversity receive port 122. The division and placement of remote repeater unit assemblies 114 into groups 116 and 118 is chosen in order to maximize the potential for diversity receive. The number of groupings of remote repeater units assemblies 114 is equal in number to the total number of receive ports on a base station 112, either simplex receive port 119 or transmit/receive port 120, and then the diversity receive port or ports 122.

This embodiment can be utilized an any distributed antenna system, including but not limited to in-building applications, distributions of antennas 113 in a linear and non-linear arrangement and the like. By way of illustration, and without limitation, a linear coverage area, such as a road, can be covered by a series of remote repeater units 111 with their corresponding antennas 113, the combined assembly 114 placed on poles, at a spacing governed by the location of the poles and the coverage area of antennas 113. All of the poles along a segment are connected to the same base station 112.

As illustrated in FIG. 24, each remote repeater unit receiver 124 on an alternate pole is placed into one of two groups 116 or 118. Each group 116 and 118 is power combined and connected to a different receive port. One group is connected to simplex receive port 119 or transmit/receive port 120, one of which will be present in a given base station 112. The other group is connected to diversity receive port 122. A mobile transmitter 123 between the poles that transmits an uplink signal has its signal received by both poles and is correctly discriminated by the receive/diversity receive on the base station 112. This can be extended to more than two groups if more receive or transmit/receive ports are available. When the distributed coverage is not arranged in a linear manner, coverage locations that are adjacent to one another are placed in the two or more different groups 116 and 118. Preferably, coverage areas are arranged into groups to increase the likelihood that a mobile transmission from a given location will be received by the two different receive ports, one by the receive port 119 or the transmit/receive port 120, and the other by the diversity receive port 122. Therefore, the members of groups 116 and 118 are chosen so that, as much as possible, geographically adjacent coverage areas are placed into different groups. Groups 116 and 118 are then coupled and combined. One into the receive port 119 or transmit/receive port 122, depending on the base station configuration, and the other into the diversity receive port 122.

In this embodiment of the present invention, the effects of Raleigh fade are significantly reduced. Raleigh fade can result from multipath which can occur as the signal travels from mobile transmitter 123 through the air to an antenna 113, or, in a distributed antenna system, due to the combination of signals from multiple antennas 113. This embodiment of the present invention provides two separate receive signals on two different receivers, and it is less likely for a null to occur at the location of both antennas 113 because two adjacent poles have different receive paths. By way of illustration, and without limitation, ˜3 dB SNR can be gained from the multiple signal path reception of this embodiment.

Another benefit of this embodiment is that the number of remote repeater units 114 that are power combined on the uplink is divided by the total number of receive ports, comprised of a simplex receive port 119 or transmit/receive port 120, and one or more diversity receive ports 122. This total number is typically two. Because power combination reduces the signal while maintaining the same noise, proportional to the number of signals that are power combined, power combining half the distributed remote repeater units 114 on the uplink yields a 3 dB improvement in uplink signal-to-noise ratio using two receive ports versus combining all the distributed remote repeater units 114 into a single receive port 119 or single transmit/receive port 120. Greater improvements result from more receive ports. This is particularly suitable for fiber fed systems because fiber link noise figure can make the link uplink limited. In the repeater systems that are used to implement this type of base station link, the link budget, meaning the coverage area, can often be determined by the uplink noise figure, not the downlink transmit power. However, in any power combined system, this improvement can be realized. By splitting the uplinks into multiple groups 116 and 118, and coupling them into simplex receive port 119 or duplex transmit/receive port 120 and diversity receive ports 122, the performance of system 110 is improved.

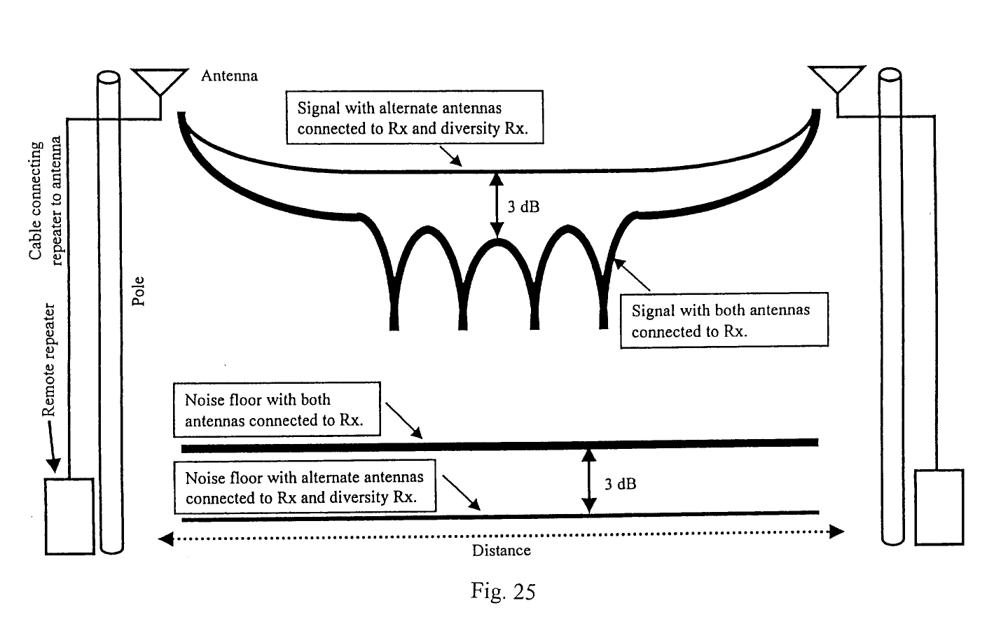

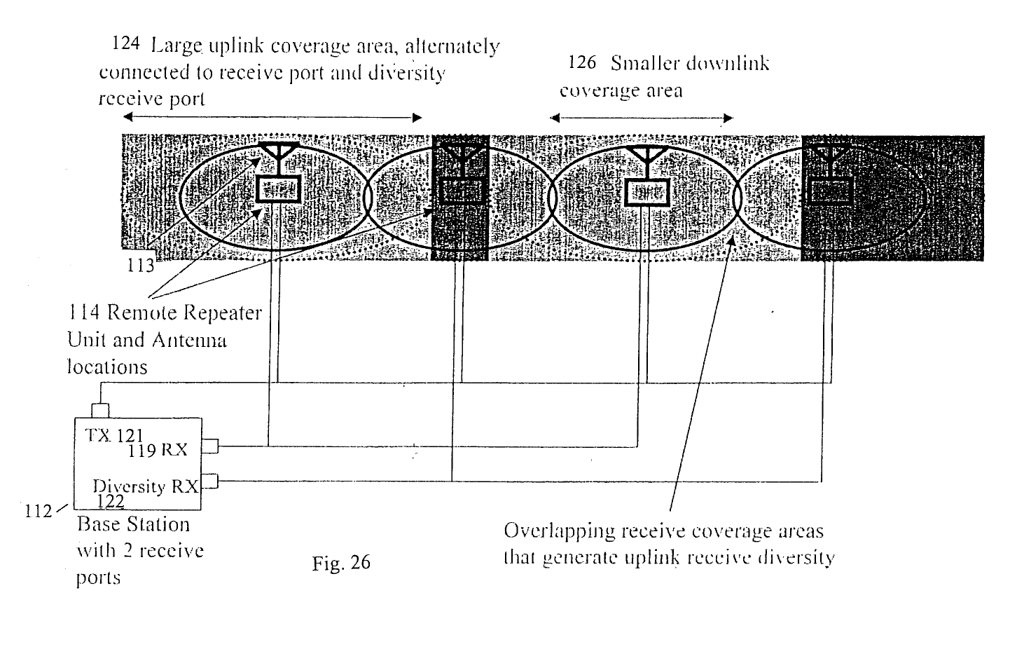

The improvement in uplink Raleigh fade, potential improvement in uplink signal, and decrease in uplink noise floor are illustrated in FIG. 25. As shown in FIG. 25, receive signal no longer experiences extensive Raleigh fading from being the power combined sum of the receive signals from both remote repeater units 114, and is 3 dB higher in the center between the poles, assuming the BTS has multiple receive paths for each receive port, so it can combine the demodulated signals. In addition, the noise floor drops by 3 dB as the number of poles that are power combined is divided by two.

In certain circumstances, coverage situations can exist in a distributed antenna system in which the coverage areas are downlink limited, not uplink limited. Such a situation is illustrated in FIG. 126. In such an area, the uplink coverage area 124 is larger than the downlink coverage area 126. In various embodiments, the present invention places the remote repeater units 111 with their corresponding antennas 113 such that the uplink coverage areas are overlapping, even if the downlink coverage areas are not overlapped. Multiple remote repeater units 114 can receive the same uplink signal, and so they can be coupled to the base station 112 to take advantage of the invention. With two receive ports, remote repeater units 114 are placed into two different groups 116 and 118 to maximize the opportunity for diversity uplink reception, and then one group is power combined and connected to the simplex receive port 119 or duplex transmit/receive port 120 and the other group is power combined and connected to diversity receive port 122. This can be extended to as many groups as the base station 112 has total receive ports.

The foregoing description of preferred embodiments of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A network, comprising:
a plurality of antennas remotely located from and optically coupled to a base station having a plurality of receive or transmit/receive ports, the plurality of antennas being split into a plurality of groups that is equal in number to a number of the plurality of receive ports, wherein the uplink signals from each grouping of the plurality of antennas are connected to one of the plurality of receive ports of the base stations by signal combination; and
a plurality of links that couple the plurality of remotely located antennas and the plurality of base stations.

2. The network of claim 1, wherein each grouping of the plurality of antennas into the plurality of groups is selected to minimize uplink Raleigh fade.

3. The network of claim 2, wherein Raleigh fade is a fast fading in a wireless system created by at least one of a reception or combining of multiple signal paths.

4. The network of claim 1, wherein the plurality of receive or transmit/receive ports has a first receive or transmit/receive port and a second receive port.

5. The network of claim 4, wherein the plurality of receive ports has a first transmit/receive port and a second diversity receive port.

6. The network of claim 4, wherein the first receive port is a standard receive port and the second receive port is a diversity port.

7. The network of claim 1, wherein the plurality of receive or transmit/receive ports has a first, a second and a third receive or transmit/receive port.

8. The network of claim 7, wherein the first receive port is a standard receive or transmit/receive port and the second and third receive ports are diversity receive ports.

9. The network of claim 1, wherein the plurality of antennas are physically arranged linearly one after another.

10. The network of claim 9, wherein the plurality of receive ports has a first and a second receive or transmit/receive ports, and antennas positioned adjacent to each other are placed in different groups, where the uplink signals from one group are connected to the first port and the uplink signals from other group are coupled to the second port.

11. The network of claim 1, further comprising:
at least a first signal combiner positioned between a group of a plurality of antennas and an associated receive port for the group of the plurality of antennas.

12. The network of claim 11, wherein the base station has a standard receive or transmit/receive port and a diversity receive port, and the plurality of antennas are divided into first and second groups and uplinks of each group are each combined by at least one signal combiner prior to being received at each receive port of the associated base station.

13. The network of claim 12, wherein the uplinks of each group are combined to produce a single combined signal that is received by a receive or transmit/receive port of the associated base station.

14. A network, comprising:
a plurality of antennas coupled to a base station having a plurality of receive or transmit/receive ports, the plurality of antennas being split into a plurality of groups that is equal in number to a number of the plurality of receive ports, wherein the uplink signals from each grouping of the plurality of antennas are connected to one of the plurality of receive ports of the base stations by signal combination; and
a plurality of links that couple the plurality of antennas and the plurality of base stations.

15. The network of claim 14, wherein the plurality of antennas are optically coupled to the base station.

16. The network of claim 14, wherein the plurality of antennas are RF coupled to the base station.

17. The network of claim 14, wherein the plurality of antennas are wirelessly coupled to the base station.

18. The network of claim 14, wherein the plurality of antennas are coupled over a cable carrying electrical signals to the base station.

19. A network, comprising:
a plurality of antennas coupled by optical links to a least one RF signal combiner on the uplink to produce a single RF combined signal, the RF combined signal being coupled to a base station having a plurality of receive or transmit/receive ports, the plurality of antennas being split into a plurality of groups that is equal in number to a number of the plurality of receive or transmit/receive ports, wherein each grouping of the plurality of antennas is connected to one of the plurality of receive or transmit/receive ports of the base stations by signal combination; and
a plurality of links that couple the plurality of antennas and the plurality of base stations.

20. A network, comprising:
a plurality of antennas optically coupled to a base station having a plurality of receive or transmit/receive ports, the plurality of antennas being split into a plurality of groups that is equal in number to a number of the plurality of receive or transmit/receive ports, wherein the uplink signals from each grouping of the plurality of antennas are connected to one of the plurality of receive or transmit/receive ports of the base stations by signal combination;
a plurality of links that couple the plurality of antennas and the plurality of base stations; and
wherein a coverage area generated by a downlink signal is smaller than a coverage area generate by an uplink signal, and the coverage area is arranged such that remote nodes connected to different receive ports have larger overlapping uplink coverage areas than overlapping downlink coverage areas.

21. The network of claim 20, where the remote nodes are constructed to emit downlink output power by cellular transmission standards of less than 1 watt.

22. The network of claim 20, where the antennas are arranged in a linear or grid pattern, and the groups consist of alternating antennas and adjacent antennas uplink signals are connected to different transmit/receive or receive ports, allowing the overlapping uplink coverage areas.

23. A network, comprising:
a plurality of remote repeater units and their corresponding antennas remotely located from and coupled to a base station having a plurality of receive or transmit/receive ports, the plurality of remote repeater units and their corresponding antennas being split into a plurality of groups that is equal in number to a number of the plurality of receive ports, wherein the uplink signals from each grouping of the plurality of remote repeater units are connected to one of the plurality of receive ports of the base stations by signal combination; and
a plurality of links that couple the plurality of remotely located remote repeater units and their corresponding antennas and the plurality of base stations.

24. The network of claim 23, wherein the plurality of remote repeater units are optically coupled to the base station.
